(19) United States
(12) Patent Application Publication
(10) Pub. No.: US 2013/0020835 A1
(43) Pub. Date: Jan. 24, 2013

(54) STRUCTURAL TUBE AND METHOD

(71) Applicant: Joseph Szuba, Dearborn, MI (US)

(72) Inventor: Joseph Szuba, Dearborn, MI (US)

(73) Assignees: Value Extraction LLC, Dearborn, MI (US); Szuba Consulting, Inc., Dearborn, MI (US)

(21) Appl. No.: 13/553,180

(22) Filed: Jul. 19, 2012

Related U.S. Application Data
(60) Provisional application No. 61/510,601, filed on Jul. 22, 2011.

(51) Int. Cl. B62D 25/04; B32B 1/08; F16L 9/00; B23K 31/02

(52) U.S. Cl. 296/193.06; 228/152; 428/600; 138/177

(57) ABSTRACT

A structural metal tube having a variable thickness varying between a minimum thickness and a maximum thickness providing structural rigidity and support for the tube. The structural tube may be polygonal, such as rectangular and utilized as an automotive A pillar, wherein the thicker wall provides a support for a hinge plate. The method includes rolling the desired configuration of the tube and welding the thinner edges.

### RELATED APPLICATIONS

This application claims priority to a Provisional Patent Application filed Jul. 22, 2011, Ser. No. 61/510,601 and to a Non-Provisional Patent Application filed Feb. 24, 2012, Ser. No. 13/404,076 which claims priority to Provisional Application Nos. 61/510,601, filed Jul. 22, 2011 and 61/446,552 filed Feb. 25, 2011.

### FIELD OF THE INVENTION

This invention relates to a structural tube and method of forming the tube, wherein the tube has a variable thickness providing structural strength and rigidity while reducing weight. An example of the structural tube of this invention is a rectangular automotive A pillar, wherein the outer wall has a substantially greater thickness than the sides and inner wall.

### BACKGROUND OF THE INVENTION

Structural tubes or pipes are used in many applications, including the industrial, automotive and construction industries which require that the structural tubes provide rigidity and structural support. Structural tubes may be formed from any metal, including steel, High Strength Low Alloy steels, (HSLA), aluminum and aluminum alloys. Structural steel tubes are used, for example, in the automotive industry for the side pillars, including the A pillar.

However, structural tubes generally have a constant wall thickness and are heavy to provide sufficient strength, support and rigidity for the required applications. There is therefore a long felt need to reduce the weight of structural tubes without significantly sacrificing the structural rigidity and support.

### SUMMARY OF THE INVENTION

The structural metal tube of this invention includes an outer surface, an inner surface and a thickness measured between the outer and inner surfaces, wherein the tube has a variable thickness, varying between a minimum thickness portion and a maximum thickness portion providing structural rigidity and support and the minimum thickness reducing the weight of the tube and the metal required to form the tube, without significantly reducing the overall strength and rigidity of the tube. In one preferred embodiment, the structural metal tube of this invention has a polygonal cross-section, including a plurality of flat internal and external surfaces, and wherein the tube is formed from a metal sheet and the ends of the metal sheet are welded to form an enclosed structural tube having a welded seam located in a minimum thickness portion of the tube, thereby avoiding reducing the overall strength of the tube. In many applications, the overall strength and rigidity of the tube is not materially affected by the reduced thickness portions of the tube. As stated above, one preferred application of the structural tube of this invention is an automotive A pillar, which is rectangular in cross-section, wherein the outer wall of the pillar has a maximum thickness, the side walls have a reduced thickness and the inner wall has a minimum thickness and the weld seam extends along the inner wall. As will be understood by those skilled in this art, an automotive A pillar is reinforced with a metal plate, which is typically welded to the outer wall of the A pillar, and the door hinges are welded to the reinforcing metal plate. The reinforcing metal plate may be eliminated in this application, wherein the hinge plates may be welded directly to the outer wall of the structural tube having a thickness sufficient to support the vehicle door.

The method of forming a structural metal tube of this invention includes rolling a metal plate with a configured roller forming a metal sheet having a variable thickness, preferably having a reduced thickness adjacent the ends of the sheet. The sheet is then formed into an open seam tube having parallel adjacent edges. The method then includes welding the adjacent parallel edges of the open seam tube to form a structural tube having an outer surface, an inner surface and a thickness between the inner and outer surfaces, wherein the thickness of the tube varies between a maximum thickness providing structural support and rigidity for the structural metal tube and a minimum thickness reducing the overall weight of the structural tube and the metal required to form the tube, and wherein the welded seam is located in a minimum thickness portion of the tube to avoid significant reduction in the structural integrity of the tube.

In one preferred method of forming a structural tube of this invention, the method includes forming an open seam tube having a polygonal cross-section, including a plurality of flat internal and external surfaces, wherein at least one of the flat surfaces has a maximum thickness and the weld seam is located in a minimum thickness of the polygonal tube. Where the method of this invention is utilized to form an automotive A pillar, the method includes forming a rectangular open seam tube, including an outer wall having a maximum thickness, side wall extending perpendicular to the outer wall having a reduced thickness and end walls having a minimum thickness terminating an adjacent parallel relation, wherein the method includes welding the end walls. The method then includes welding hinge plates directly to the outer wall of the structural metal tube.

As will be understood by those skilled in this art, various modifications may be made to the disclosed embodiments of this invention within the purview of the appended claims.

The following description of the preferred embodiments is for illustrative purposes only and does not limit the scope of this invention.

### BRIEF DESCRIPTION OF THE DRAWINGS

FIG. 1 is a partial side perspective view of one embodiment of the structural tube of this invention prior to welding;

FIG. 2 is a side perspective view of FIG. 1 following welding;

FIG. 3 is a side perspective view of an automotive A pillar with a hinge plate welded to the A pillar;

FIG. 4 is an end cross-sectional view of an alternative embodiment of the structural tube of this invention; and

FIG. 5 is a side perspective view of one embodiment of a roller assembly used to form the structural tube shown in FIGS. 1 and 2.

### DESCRIPTION OF THE PREFERRED EMBODIMENTS

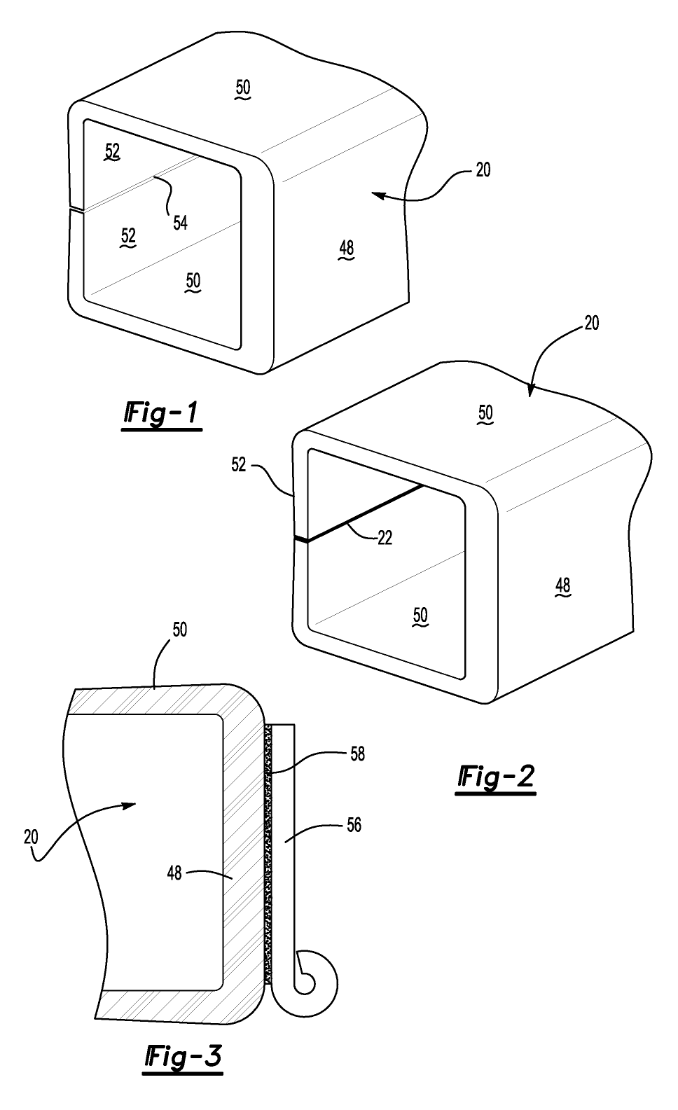

As set forth above, the embodiments of the structural tube and method of forming same disclosed in the drawings are for illustrative purposes only and thus do not limit the invention. FIG. 1 illustrates one embodiment of a structural tube of this invention prior to welding. FIG. 2 shows the same structural tube following welding of the adjacent edges at 22. FIG. 5 illustrates one embodiment of a configured roller assembly for rolling the configuration of the structural tube 20 shown in FIGS. 1 and 2. This embodiment of the roller assembly includes an upper roller 24 configured to form the structural tube 20 shown in FIGS. 1 and 2 and a cylindrical lower roller 26. The rollers are rotatably supported on axes 28 and 30. The rollers 24 and 26 are rotated in the direction shown by arrows 32. In this embodiment, the upper roller 24 includes a reduced diameter cylindrical central portion 34, opposed frustoconical surfaces 36 and frustoconical or sloping sides 38. A metal sheet 40 is rolled between the rollers forming a minor image of the upper roller, including a thicker central portion 42, frustoconical portions 44 on opposed sides of the central portion 42 and tapered ends 46. As will be understood by those skilled in the art of metal forming, various configurations of rollers may be used to form a metal sheet having a thickened central portion and frustoconical side portions, including rollers which are permitted to flex in the central portion forming either a convex or concave central portion or a series of progressive rollers may also be utilized which will depend in part upon the metal sheet formed by the method of this invention.

The sheet 40 may then be formed into the open seam tube 20 shown in FIG. 1 using progressive dies as would be understood by those skilled in this art. The resultant open seam tube 20 includes one wall 48 having a substantially greater thickness than the remaining walls, which include side wall 50 extending perpendicular to the thicker wall 48 having a thickness less than the wall 48 and end walls 52 extending perpendicular to the side wall 50 having a thickness less than the side walls 50. As shown in FIG. 1, the end walls 52 terminate in parallel closely spaced edges 54 suitable for welding. As will be understood by those skilled in this art, the closely spaced parallel edges 54 may be welded by any suitable means, including TIG welding or heat forging wherein the edges 54 are heated by an induction heater and the edges are driven together by rollers (not shown) when the edges 54 reach the forging temperature.

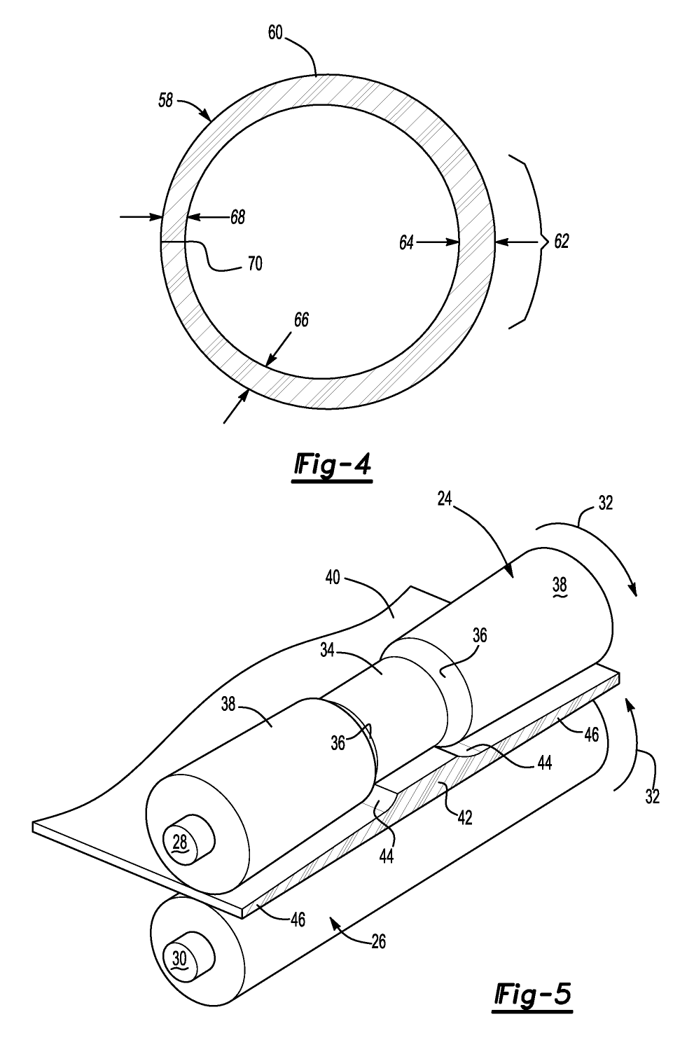

As will be understood, the structural tube of this invention may be used for various applications including, for example, only, a vehicle A pillar. A typical vehicle A pillar is rectangular and has a reinforcing plate welded to it and hinge plates are welded to the reinforcing plate for support of the vehicle doors. However, in this embodiment of the structural tube of this invention, the outer wall 48 is thick enough to provide structural rigidity and the hinge plate 56 may be welded directly to the outer wall 48 as shown by weld 58 in FIG. 3. As will be understood by those skilled in this art, an A pillar extends vertically between the front and back doors in a vehicle, such as a car or truck.

As will be understood from the description above of one embodiment of the structural tube and method of forming same of this invention, the shape or configuration of the structural tube will depend upon the application. For example, the tube may be polygonal having six or eight flat sides or the tube may be cylindrical as shown in FIG. 4, wherein the tube includes a thicker wall portion 62 having a first thickness 64, a second thickness 66, which is thinner than the first thickness 64, and a third thickness 68 which is thinner than the first and second thicknesses 64 and 66 and the cylindrical tube is welded at 70.

Having described various embodiments of the structural tube and method of manufacture of this invention, it will be understood that various modifications may be made to these embodiments and the method of forming same within the purview of the appended claims.

1. A structural metal tube, comprising: a tube having an outer surface, an inner surface, and a thickness measured between the outer and inner surfaces, wherein the structural tube has a variable thickness varying between a minimum thickness portion, a maximum thickness portion provided structural rigidity and support and a minimum thickness portion reducing the overall weight of the tube and the metal required to form the structural metal tube.

2. The structural metal tube as defined in claim 1, wherein the tube is polygonal having a plurality of flat inner and outer surfaces, and wherein the tube is formed from a metal sheet with the ends of the metal sheet welded to form an enclosed polygonal tube having a welded seam located at a minimum thickness portion of the tube.

3. The structural metal tube as defined in claim 2, wherein a structural member is welded directly to a flat external surface of said polygonal tube having a maximum thickness.

4. The structural metal tube as defined in claim 3, wherein the tube is rectangular and oriented vertical to form an automotive A pillar, including a flat outer side having a maximum thickness and an inner side having a minimum thickness with the welded seam, and the structural member comprises a plurality of vehicle door hinges, each having a hinge plate welded directly to the exterior surface of the metal A Pillar tube.

5. A method of forming a structural metal tube, comprising the following steps:
rolling a metal plate with a configured roller forming a metal sheet having a variable thickness;
forming the metal sheet into an open seam tube having adjacent parallel edges;
welding the adjacent edges of the open seam tube to form a structural tube having an outer surface, an inner surface, and a thickness between the inner and outer surfaces varying between a maximum thickness portion providing structural integrity and support and rigidly supporting the structural metal tube and a minimum thickness reducing the weight of the structural metal tube and the metal required to form the tube with the welded seam located in a minimum thickness portion of the tube.

6. The method as defined in claim 5, wherein the method includes forming a polygonal open seam metal tube having a plurality of flat internal and external surfaces, and wherein at least one of the flat surfaces has a maximum thickness, and welding the opposed edges forming an enclosed structural metal tube.

7. The method as defined in claim 6, wherein the method includes forming a rectangular open seam metal tube including one wall having a maximum thickness, two side walls integral with and extending perpendicular to the side walls having a reduced width and end walls extending perpendicular to the side walls having adjacent edges, welding the adjacent edges of the end walls, and welding hinge plates to the side wall, forming an automotive A pillar.
